(19) United States
(12) Patent Application Publication
(10) Pub. No.: US 2008/0141543 A1
(43) Pub. Date: Jun. 19, 2008

(54) CUTTING ELEMENT STRUCTURE FOR GARDEN TRIMMER

(76) Inventor: Lauro GUERRA, Correggio (IT)

Correspondence Address: LADAS & PARRY, 5670 WILSHIRE BOULEVARD, SUITE 2100, LOS ANGELES, CA, 90036-5679, US

(21) Appl. No.: 12/019,007

(22) Filed: Jan. 24, 2008

Related U.S. Application Data
(63) Continuation-in-part of application No. 11/499,865, filed on Aug. 3, 2006.

(30) Foreign Application Priority Data
Aug. 3, 2005 (IT) MI2005U 000288

(51) Int. Cl. B26B 7/00

(52) U.S. Cl. 30/347

(57) ABSTRACT

The cutting element is connectable to a trimmer head of a garden trimmer. The cutting element comprises a body which is pivotable to the trimmer head along a pivoting axis parallel to the axis of rotation of the head. From the body extends one or more flexible arms, wherein an end portion of each arm opposite to the body has a cross-section which is compressed along the direction of the pivoting axis, and an intermediate portion of each arm interposed between said end portion and said body has a cross-section compressed along a direction perpendicular to the pivoting axis.

This application is a continuation-in-part of my co-pending application Ser. No. 11/499,865, filed Aug. 3, 2006.

### FIELD OF THE INVENTION

The present invention relates to so-called garden trimmers and more particularly to garden trimmers of the corded head type.

### BACKGROUND OF THE INVENTION

Garden trimmers are known devices for cutting grass, weeds and similar vegetation. They comprise a rotating head from which the two or more ends of a cord of suitable plastic material radially project symmetrically.

The head is rotatably supported at the end of a support and gripping structure, usually in the form of a bar, to the other end of which an internal combustion engine or electric motor is fixed.

The support structure encloses a device for transmitting rotary motion from the motor or engine shaft to the head and also comprises gripping means which enable the user to correctly grip the trimmer for its use.

### DISCUSSION OF THE RELATED ART

Two groups of heads currently exist:
a first group of heads in which the cord is wound about a spool with its ends radially projecting symmetrically therefrom through a bush;
a second group of heads provided with a piece of cord retained by a ring nut coaxial to the head and fixable to this latter by screwing.

The bush presents peripheral slits through which the pieces of cord are inserted so that their ends project outwards, or holes provided with non-return catches.

As is well known to the user of trimmers provided with heads of the first group, one of the most annoying and frequent problems is that the two cord pieces projecting from the head, to form the part which materially cuts the vegetation when the head rotates, frequently break at the respective radial exit apertures.

From tests carried out it has been proved that the shearing of the cord at the head exit is due to fatigue. In this respect, by observing the phenomenon under stroboscopic light, it has been found that during trimmer operation the cord, which emerges essentially radially from the head, flexes continuously and irregularly in both directions about the radial direction of the head, through a maximum angle of about 180° (90° towards one side and 90° towards the other side about this radial direction).

It has also been verified that the cutting force discharges on the bush as a traction force, the consequent rubbing heating the cord until it melts, causing it to break.

The heads of the second group comprising cord pieces also present certain problems, and in particular:

the cord pieces have round or square cross-sections of not inconsiderable dimensions (up to 4.2 millimetres) in order to increase their working life, this resulting in a considerable increase in noise and absorbed power;

as they are rigidly fixed by compression, the cord pieces tend to break close to the ring nut, on which the entire cutting force is discharged on encountering rigid obstacles close to the head;

the cord pieces are rather laborious to mount, requiring a tool to release the fixing nut.

U.S. Pat. No. 6,119,350 discloses a cutter element having a body from which an arm extends.

The arm has a constant cross-section which causes a noisy working and high probability of breakage.

U.S. Pat. No. 6,161,292 discloses a cutting element having a compressed shape along the axis of rotation. This cutting element breaks at the border connected to the cutting head.

### SUMMARY OF THE INVENTION

The aim of the present invention is therefore to provide a cutting structure for a trimmer by which the said problems of the known art are eliminated.

Within the scope of this aim, specific objects are to provide a cutting structure which:

prevents the cord breaking at the cord exit aperture in the head or considerably reduces the frequency of this phenomenon;

enables the cord to be easily and quickly replaced without excessive force;

limits noise;

provides a higher cutting quality.

The technical aim, together with these and further objects, are attained according to the invention by providing a cutting element structure for garden trimmer in accordance with the accompanying claims.

A further aim of the present invention is to provide a cutting element which has a noiseless working and which is very strong, such that it has a very low probability of breakage.

### BRIEF DESCRIPTION OF THE DRAWINGS

Further characteristics and advantages will be more apparent from the description of a preferred but non-exclusive embodiment of the cutting element structure for a garden trimmer according to the invention, illustrated by way of non-limiting example in the accompanying figures, in which:

FIG. 1 is a coaxial section through a garden trimmer head provided with a cutting element of the invention; the cutting element is shown at a stage during its extraction from the head;

FIG. 2 shows the next stage during the extraction of the cutting element after FIG. 1;

FIG. 3 shows a cutting element of the invention during its insertion into a garden trimmer head;

FIG. 4 shows a garden trimmer head provided with a cutting element of the invention;

FIG. 5 is a perspective view of the trimmer head with the cutting elements applied;

FIGS. 6, 7, 8, 9 show four different embodiments of a cutting element of the invention;

FIGS. 10-25 show different cross-sectional forms for the elongate elements or arms of the cutting elements according to the invention; and

FIGS. 26-30 show a different embodiment of the cutting element according to the invention;

FIGS. 31-35 show a further embodiment of the cutting element according to the invention;

FIGS. 36-37 show one more embodiment of the cutting element according to the invention; and

FIGS. 38-39 show an embodiment similar to that of FIGS. 36-37, but having two arms.

### DETAILED DESCRIPTION OF THE INVENTION

With reference to said figures, these show a cutting element for a garden trimmer.

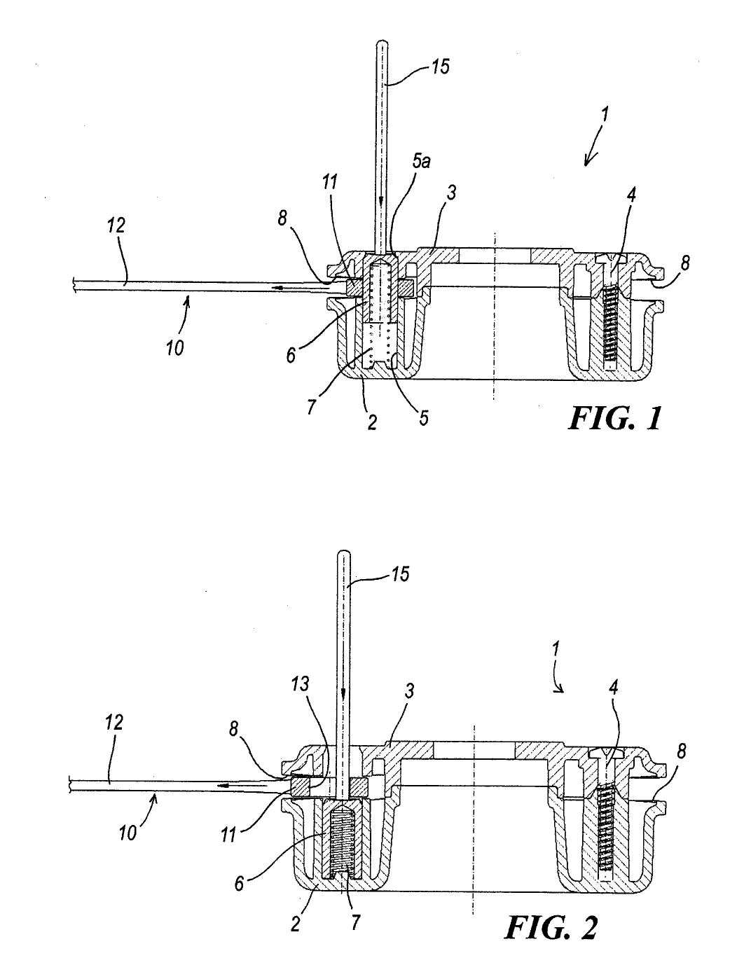

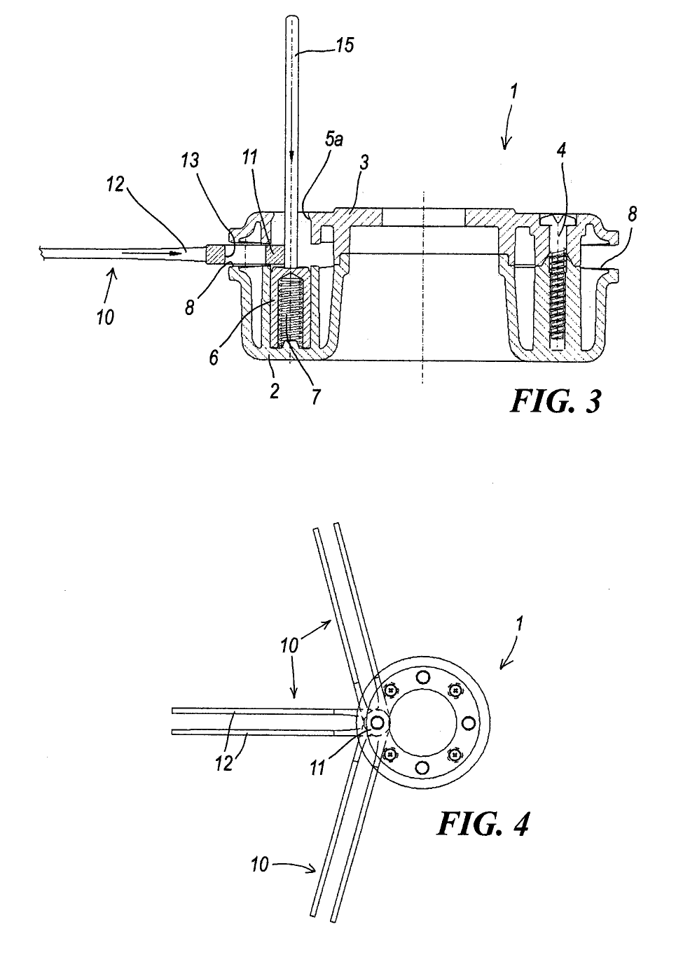

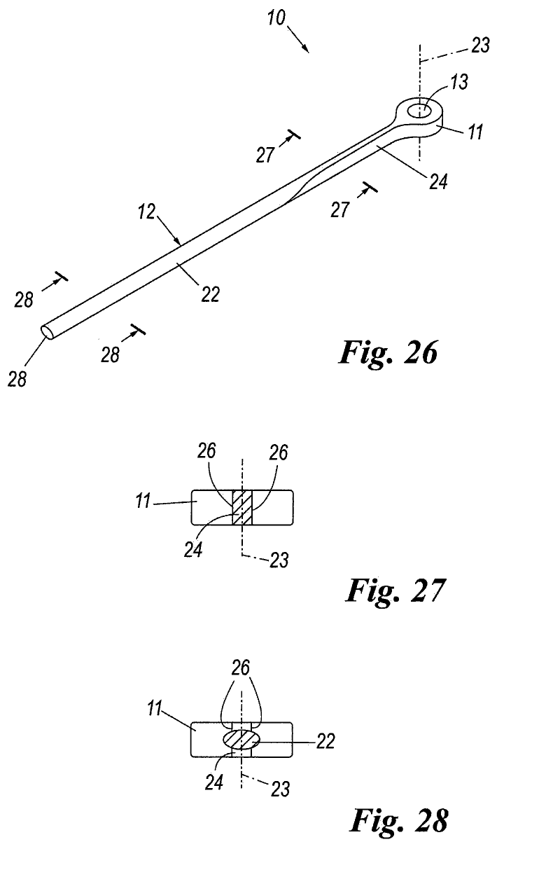

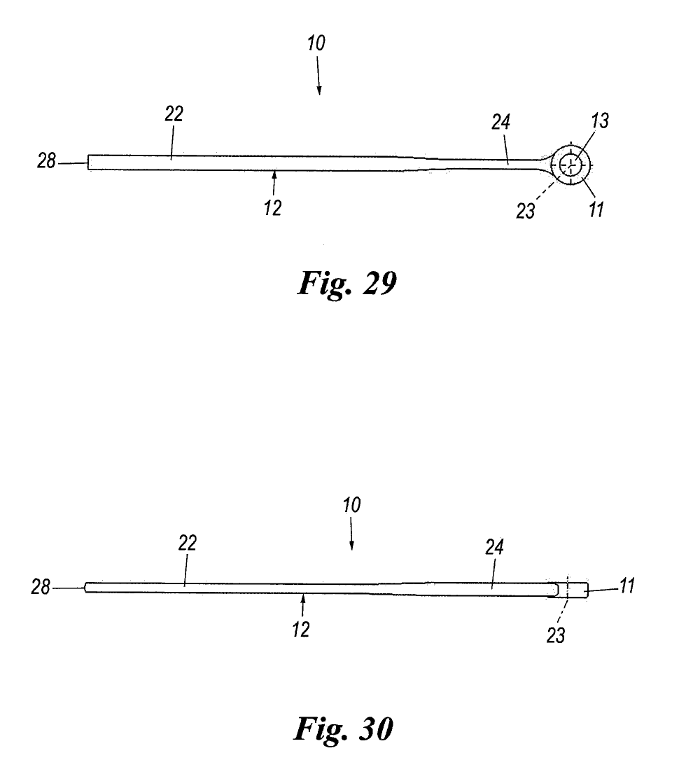

Specifically, FIGS. 1-5 show a garden trimmer head provided with said cutting element and indicated overall by the reference numeral 1.

The trimmer head 1 comprises a first casing 2 to which a second casing 3 is fixed by screws 4.

The first casing 2 presents recessed seats 5 into each of which a pin 6 is slidably inserted, movable against and by the action of a spring 7.

Each seat 5 presents a converging (at 5a) free end defining a limit stop for the pin 6.

In addition, the casings 2, 3 laterally define apertures 8 through which pass the cutting elements 10, which are housed in the seat 5 and project from it.

In different embodiments, one, two, three, four or even more cutting elements 10 can project from the trimmer head.

The cutting elements 10 comprise a body 11 connectable to the trimmer head 1.

The body 11 has an annular structure and presents a circular through hole 13 for receiving the trimmer locking pin 6.

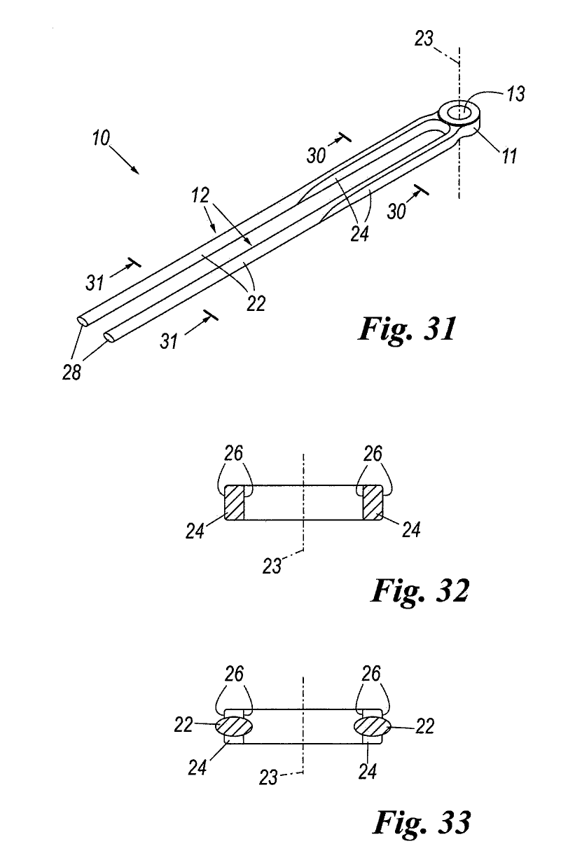

In addition, as shown in FIGS. 6-9, there can extend from the body 11 a single elongate element or flexible arm 12 or, in other examples, a pair of elongate elements or flexible arms 12 disposed in a plane perpendicular to the rotation pin, and which can be rectilinear and parallel, or curved in the same direction (FIG. 8), or divergent (FIG. 9), or convergent (arrangement not shown).

In a different example, the elongate elements of each cutting element are four in number, lying in pairs in relative spaced-apart planes perpendicular to the axis of the respective rotation pin.

Advantageously the elongate element or arm or arms of the cutting element 10 have that axis on which the body is pivoted to the trimmer head parallel to the axis of rotation of the head.

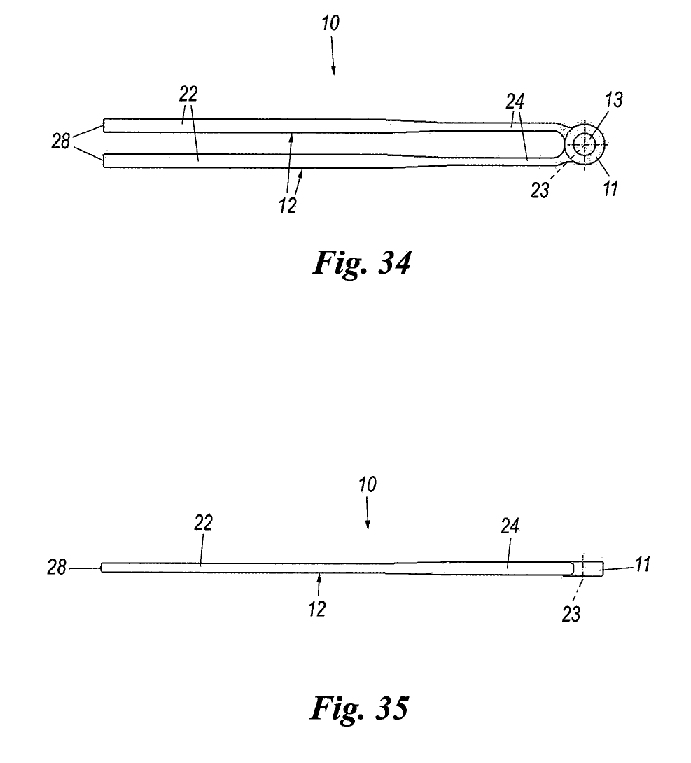

The elongate elements or arms present a substantially elliptical or ovoidal or ellipsoidal cross-section, or a cross-section otherwise compressed in the direction of the pivoting pin, to narrow from the pivoted body towards their free end, so that it more easily cuts through the air; other cross-sectional forms (FIGS. 10-25) can also be used.

The body 11 and the cutting element 12 are moulded in one piece from plastic material such as nylon; they also present elastic characteristics which enable them to bend, so limiting risks of breakage.

The operation of the cutting element of the invention is apparent from that described and illustrated and is substantially the following.

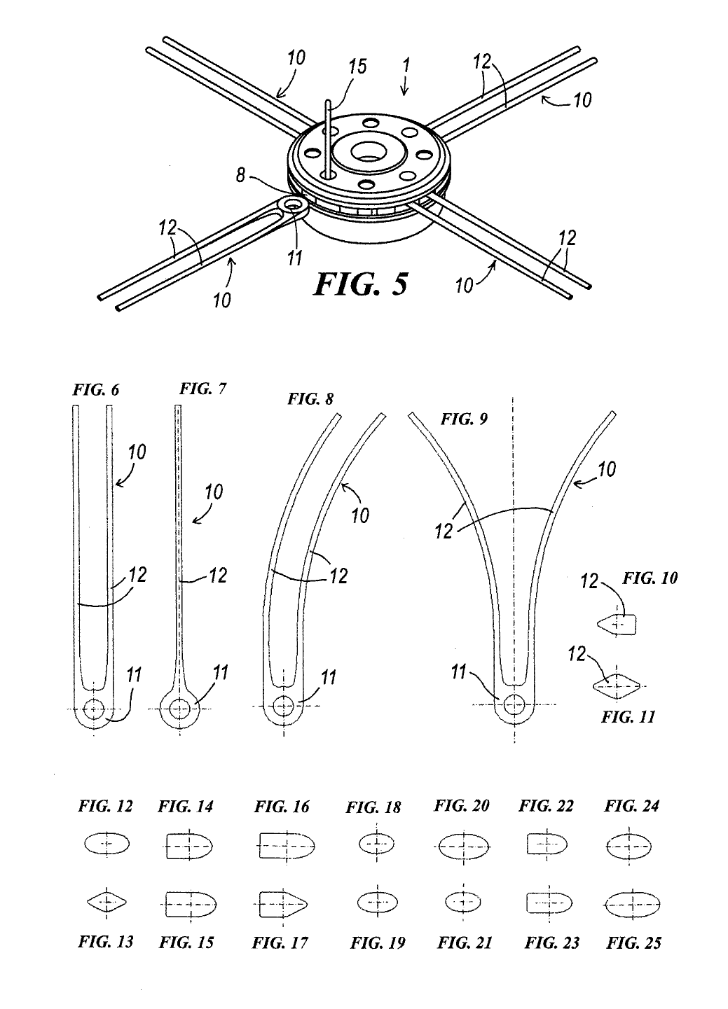

It is mounted in the trimmer head (FIG. 3) by pressing, with a tool 15, the pin 6 so that it enters the seat 5, then inserting the element 10 (specifically the body 11) as far as above the pin 6, then withdrawing the tool 15 such that the through hole 13 corresponds with the pin 6, so that when the pin 6 returns to its rest position, it becomes inserted through the hole 13.

Extraction is achieved by pressing the pin 6 with the tool 15 so that the pin 6 withdraws from the through hole 13 and the body 11 mounts the pin 6, after which the tool 15 is withdrawn and the element 10 extracted.

Advantageously, during operation the fact that the particular section through the elongate elements or arms of the cutting element is compressed in the direction of the axis of the pin 6 means that the cutting element produces less noise than cutting elements of the known art.

Moreover, during rotation the cutting element is pivoted on the pin 6 and can slip relative thereto (while rotating). This limits the forces within the elongate elements or arms of the cutting element, hence limiting their breakage close to the head when they encounter rigid obstacles.

By virtue of the particular structure and the particular connection system, the cutting element of the invention can be in the form of elongate elements or arms which are very thin in the direction of the pin 6. In addition to reducing the noise which they generate during rotation, this also enables the vegetation to be very precisely cut (in terms of quality).

Different embodiments of the cutting element are possible. For example, in a different embodiment the body 11 is in the form of two shells connected together by screws or snap hooks. The two shells are provided with seats to receive and retain the elongate elements or flexible arms 12.

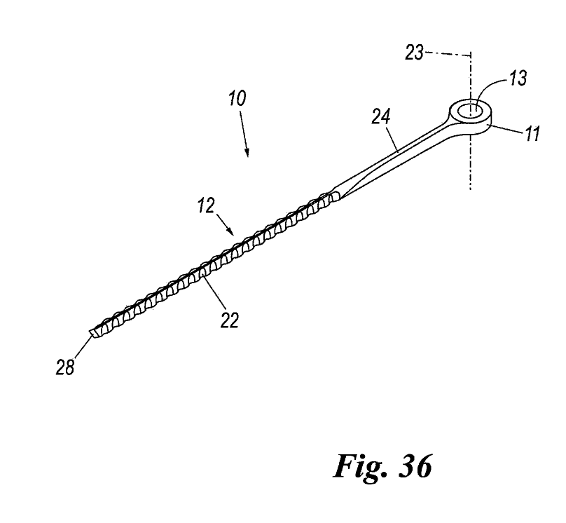

FIGS. 26-30 show a further embodiment of the cutting element of the invention.

In this embodiment the cutting element 10 connectable to a trimmer head of a garden trimmer comprises a body 11, which is pivotable to the trimmer head along a pivoting axis 23 which is parallel to the axis of rotation of the head.

From the body 11 extends one or more flexible arms 12.

An end portion 22 of each arm 12 opposite to the body 11 has a cross-section which is compressed along the direction of the pivoting axis 23; in other words the maximal length of the cross-section in the direction of the axis 23 is shorter than the length of the cross-section in a direction perpendicular to the axis 23.

As shown in the drawings (FIG. 28), the cross-section through said end portion 22 is ovoidal or ellipsoidal.

Moreover, an intermediate portion 24 of each arm 12 interposed between the end portion 22 and the body 11 has a cross-section which is compressed along a direction perpendicular to the pivoting axis 23; in other words the maximal length of the cross-section in a direction perpendicular to the axis 23 is shorter than the length of the cross-section in the direction of the axis 23.

Preferably the intermediate portion 24 has a cross-section with walls 26 parallel to the pivoting axis 23 and plane in shape.

In particular said intermediate portion 24 is cross-section quadrangular in shape and preferably rectangular in shape (FIG. 27) with longer sides parallel to the axis 23. The cross section through the intermediate portion 24 may also be ovoidal or ellipsoidal in shape, with longer dimension parallel to the pivoting axis 23.

The cross-section through the arms 12 may narrows or widens in a direction perpendicular to the pivoting axis 23 from the body 11 towards a free end 28 of the end portion 22.

In addition, the cross-section through the arms 12 may also narrow along the direction of the pivoting axis from the body towards a free end of the end portion.

In particular (FIG. 29), the cross-section through the arms 12 widens because the arms (during operation, i.e. during cutting) wear starting from the free end 22; i.e. by making the end portion 22 wider, the arms have a longer working life.

Preferably the body 10 and the arms 12 are formed in one single piece and are made of a plastic material such as nylon; in addition the arms 12 present elastic characteristics.

The body 11 presents a through hole 13 into which a relative pin can be inserted for pivoting the head to the trimmer.

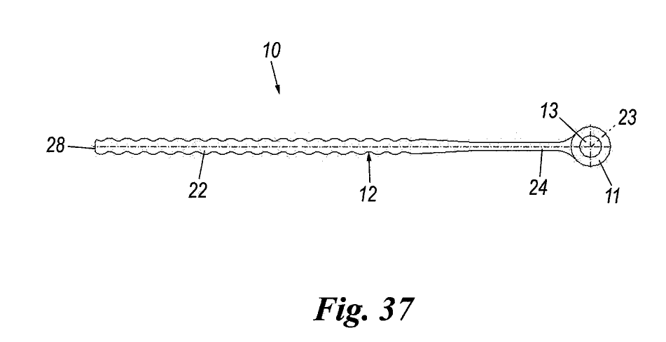

In different embodiments (see FIGS. 31-35) the cutting element 10 of the invention comprises at least two arms (in further embodiments four or a different number) which are rectilinear and parallel to each other, or curved.

Preferably, the arms are disposed in a plane perpendicular to the pivoting axis.

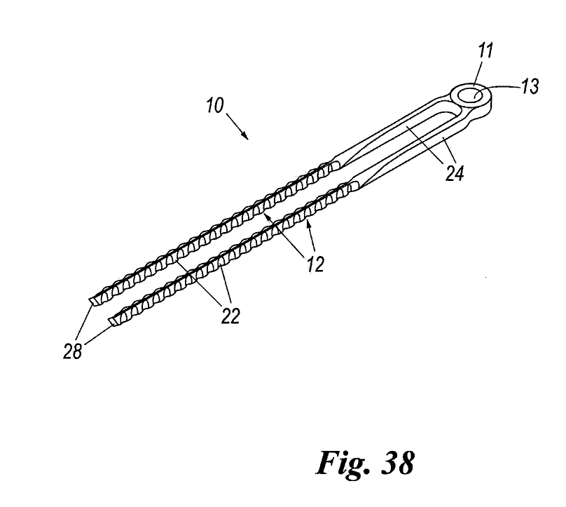

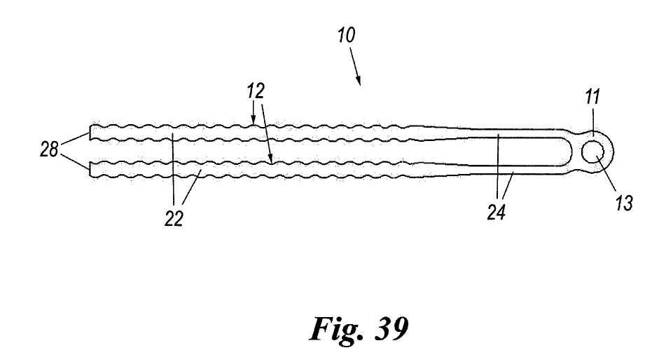

FIGS. 36-37 show a further embodiment of a cutting element 10 with the end portion 22 which is jagged and FIGS. 38-39 show an embodiment of a cutting element 10 with two arms having their end portions 22 which are jagged.

In practice it has been found that garden trimmer cutting structure of the present invention enables cutting elements to be provided which are resistant to tearing, of low noise, and have thin elongate elements or arms which are precise in their cutting.

In practice the materials used and their dimensions can be chosen at will in accordance with requirements and the state of the art.

What I claim is:

1. A cutting element connectable to a trimmer head of a garden trimmer, said cutting element comprising a body which is pivotable to the trimmer head along a pivoting axis parallel to the axis of rotation of the head, from said body extending one or more flexible arms, wherein an end portion of each arm opposite to the body has a cross-section which is compressed along the direction of the pivoting axis, and an intermediate portion of each arm interposed between said end portion and said body has cross-section plane walls parallel to said pivoting axis.

2. A cutting element as claimed in claim 1, wherein said intermediate portion is compressed along a direction perpendicular to the pivoting axis.

3. A cutting element as claimed in claim 2, wherein said cross-section through said intermediate portion is quadrangular in shape and preferably rectangular in shape.

4. A cutting element as claimed in claim 1, wherein the cross-section through said end portion is ovoidal or ellipsoidal.

5. A cutting element as claimed in claim 1, wherein the cross-section through the arms narrows in a direction perpendicular to the pivoting axis from the body towards a free end of the end portion.

6. A cutting element as claimed in claim 1, wherein the cross-section through the arms narrows along the direction of the pivoting axis from the body towards a free end of the end portion.

7. A cutting element as claimed in claim 1, wherein the cross-section through the arms widens in a direction perpendicular to the pivoting axis from the body towards a free end of the end portion.

8. A cutting element as claimed in claim 1, wherein the body and said arms are formed in one piece and are made of a plastic material such as nylon.

9. A cutting element as claimed in claim 1, wherein each arm presents elastic characteristics.

10. A cutting element as claimed in claim 1, wherein said body presents a through hole into which a relative pin can be inserted for pivoting the head to the trimmer.

11. A cutting element as claimed in claim 1, further comprising a plurality of arms which are rectilinear and parallel to each other, or curved.

12. A cutting element as claimed in claim 11, wherein the arms of the cutting elements are two in number, disposed in a plane perpendicular to the pivoting axis.

13. A cutting element as claimed in claim 1, wherein the end portion of each arm is jagged.

14. A cutting element connectable to a trimmer head of a garden trimmer, said cutting element comprising a body which is pivotable to the trimmer head along a pivoting axis parallel to the axis of rotation of the head, from said body extending one or more flexible arms, wherein an end portion of each arm opposite to the body has a cross-section which is compressed along the direction of the pivoting axis, and an intermediate portion of each arm interposed between said end portion and said body has a cross-section compressed along a direction perpendicular to the pivoting axis.

15. A cutting element as claimed in claim 14, wherein the cross-section through said end portion is ovoidal or ellipsoidal.

16. A cutting element as claimed in claim 14, wherein the cross-section through the arms narrows in a direction perpendicular to the pivoting axis from the body towards a free end of the end portion.

17. A cutting element as claimed in claim 14, wherein the cross-section through the arms narrows along the direction of the pivoting axis from the body towards a free end of the end portion.

18. A cutting element as claimed in claim 14, wherein the cross-section through the arms widens in a direction perpendicular to the pivoting axis from the body towards a free end of the end portion.

19. A cutting element as claimed in claim 14, wherein the body and said arms are formed in one piece and are made of a plastic material such as nylon.

20. A cutting element as claimed in claim 14, wherein each arm presents elastic characteristics.

21. A cutting element as claimed in claim 14, wherein said body presents a through hole into which a relative pin can be inserted for pivoting the head to the trimmer.

22. A cutting element as claimed in claim 14, further comprising a plurality of arms which are rectilinear and parallel to each other, or curved.

23. A cutting element as claimed in claim 22, wherein the arms of the cutting elements are two in number, disposed in a plane perpendicular to the pivoting axis.

24. A cutting element as claimed in claim 14, wherein the end portion of each arm is jagged.
